(19) United States
(12) Patent Application Publication
(10) Pub. No.: US 2016/0349945 A1
(43) Pub. Date: Dec. 1, 2016

(54) DISPLAY APPARATUS AND METHOD FOR CONTROLLING THE SAME

(71) Applicants: SAMSUNG ELECTRONICS CO., LTD., Suwon-si (KR); EWHA UNIVERSITY - INDUSTRY COLLABORATION FOUNDATION, Seoul (KR)

(72) Inventors: Min-jin KIM, Pyeongtaek-si (KR); Ha-yeon YOO, Seongnam-si (KR); Sang-hee LEE, Seoul (KR); Joo-sun MOON, Seoul (KR); Seung-ho PARK, Seoul (KR); Yoo-jin LEE, Seoul (KR); Bo A MIN, Seoul (KR); Byung-mi CHOI, Seoul (KR)

(73) Assignees: SAMSUNG ELECTRONICS CO., LTD., Suwon-si (KR); EWHA UNIVERSITY - INDUSTRY COLLABORATION FOUNDATION, Seoul (KR)

(21) Appl. No.: 15/085,439

(22) Filed: Mar. 30, 2016

(30) Foreign Application Priority Data
May 27, 2015 (KR) 10-2015-0074057

(51) Int. Cl. G06F 3/0482; G06F 3/0484; G06F 3/0489; H04N 21/422; G06F 3/033; H04N 5/44; H04N 5/445; G06F 3/02; G06F 3/0481

(52) U.S. Cl. CPC G06F 3/0482; G06F 3/02; G06F 3/04842; G06F 3/0489; G06F 3/04845; G06F 3/04812; G06F 3/033; H04N 5/4403; H04N 5/44543; H04N 21/42218; H04N 2005/44573; H04N 2005/4416

(57) ABSTRACT

Provided are a display apparatus controlled through an input unit including a four-direction key and a method for controlling the same. The display apparatus includes an input unit including a four-direction key and configured to receive a user command, a display unit configured to display a four-direction user interface (UI) including UI elements corresponding to the four-direction key, and a controller configured to, in response to one of the four-direction key being selected, control the display unit to display a low UI element included in a UI element corresponding to the selected key. Accordingly, a user intuitively accesses content that the user wants to enter without learning of a new interface.

### CROSS-REFERENCE TO RELATED APPLICATIONS

This application claims priority from Korean Patent Application No. 10-2015-0074057, filed on 27 May, 2015, in the Korean Intellectual Property Office, the disclosure of which is incorporated herein by reference in its entirety.

### BACKGROUND

1. Field

Apparatuses and methods consistent with the embodiments relate to a display apparatus and a method for controlling the same, and more particularly, to a display apparatus and a method for controlling the same, for providing a four-direction user interface (UI) optimized for manipulation of a remote controller with a four-direction key.

2. Description of the Related Art

Recent display apparatuses provide various functions and information items. For example, a smart television (TV) is not a simple TV only for broadcast watching and provides various functions such as web surfing, video on demand (VoD) watching, a social networking service (SNS), and game by being coupled to the Internet access function and installing various applications.

However, since it is difficult to intuitively use an interface of a smart TV for users that have used an existing TV, various functions of the smart TV are barely used.

In order to use various functions of a recent display apparatus, a user of the recent display apparatus needs to learn a new type of interface. However, the user of the display apparatus tends to give priority to an old habit to new learning and to unfavorably react to learning of new interfaces due to an experience in which a different result from an expected result is derived.

Accordingly, there are still many users who do not effectively use various functions and information items of a recent display apparatus during use of the display apparatus.

### SUMMARY

Additional aspects and/or advantages will be set forth in part in the description which follows and, in part, will be apparent from the description, or may be learned by practice of the embodiments.

Exemplary embodiments overcome the above disadvantages and other disadvantages not described above. Also, the embodiments are not required to overcome the disadvantages described above, and an exemplary embodiment may not overcome any of the problems described above.

The embodiments provide a display apparatus and a method for controlling the same, for overcoming a problem in terms of ineffective use of information of various functions and information items.

The embodiments also provide a display apparatus and a method for controlling the same, for providing an interface that reflects an existing experience of users of the display apparatus and reflects a habit of the users so as to use various functions of the display apparatus.

According to an aspect, a method for controlling a display apparatus controlled through an input unit including a four-direction key includes displaying a four-direction user interface (UI) including UI elements corresponding to the four-direction key, and in response to one of the four-direction key being selected, displaying a low UI element included in a UI element corresponding to the selected key.

The displaying of the low UI element may include displaying a plurality of UI elements in line around the UI element corresponding to the selected key.

The plurality of low UI elements may correspond to a plurality of applications, respectively, and the displaying of the plurality of UI elements may include displaying the plurality of low UI elements in line using one of a frequency of execution of the plurality of applications and a recently executed history.

The displaying of the four-direction UI may include, in response to a user command for generation of a four-direction UI during display of specific content, displaying a four-direction UI corresponding to the specific content.

The displaying of the low UI element may include adjusting the number and size of the plurality of displayed low UI elements according to the size of a display unit of the display apparatus and displaying the plurality of displayed low UI elements.

The displaying of the four-direction UI may include, in response to a user command for display of the four-direction UI being input during display of a pointer, displaying the four-direction UI around a position of the pointer.

A category of the UE element may be capable of being determined by a user.

The displaying of the low UI element may include moving a position of the four-direction UI based on the position of the four-direction UI and the number of the low UI elements.

The displaying of the four-direction UI may include, in response to a user input for selection of the UI element being input, differently displaying the selected UI element from a non-selected UI element.

According to another aspect, a display apparatus includes an input unit including a four-direction key and configured to receive a user command, a display unit configured to display a four-direction user interface (UI) including UI elements corresponding to the four-direction key, and a controller configured to, in response to one of the four-direction key being selected, control the display unit to display a low UI element included in a UI element corresponding to the selected key.

The controller may control the display unit to display a plurality of low UI elements in line around the UI element corresponding to the selected key.

The plurality of low UI elements may correspond to a plurality of applications, respectively, and the controller may control the display unit to display the plurality of low UI elements in line using one of a frequency of execution of the plurality of applications and a recently executed history.

The controller may control the display unit to display a four-direction UI corresponding to specific content in response to a user command for generation of the four-direction UI being input during display of content

The controller may control the display unit to adjust the number and size of the plurality of displayed low UI elements according to the size of a display unit of the display apparatus and to display the plurality of displayed low UI elements.

In response to a user command for display of the four-direction UI being input during display of a pointer, the controller may control the display unit to display the four-direction UI around a position of the pointer.

A category of the UE element may be capable of being determined by a user.

The controller may control the display unit to move a position of the four-direction UI based on the position of the four-direction UI and the number of the low UI elements and to display the four-direction UI.

In response to a user input for selection of the UI element being input, the controller may control the display unit to differently display the selected UI element from a non-selected UI element.

According to another aspect, a non-transitory computer readable medium storing a method for controlling a display apparatus controlled through an input unit comprising a four-direction key, the method includes displaying a four-direction graphical user interface (GUI) comprising GUI elements corresponding to the four-direction key and in response to one of the four-direction key being selected, displaying a GUI sub-element corresponding to the selected key.

According to another aspect, a method for controlling a display apparatus controlled through an input unit comprising a four-direction key, the method includes displaying a four-direction graphical user interface (GUI) comprising control GUI elements corresponding to the four-direction key and in response to one of the four-direction key controls being selected, displaying a GUI sub-control element corresponding to the selected key.

According to another aspect, a display apparatus includes an input unit comprising a four-direction key and configured to receive a user command, a display unit configured to display a four-direction graphical user interface (GUI) comprising UI elements corresponding to the four-direction key and a controller configured to, in response to one of the four-direction key being selected, control the display unit to display a the four-direction GUI, the four-direction GUI including a four-direction GUI control having four-direction-oriented GUI controls displayed on a display and corresponding GUI sub-controls corresponding to each of the four-direction-oriented GUI controls, the corresponding GUI sub-controls being displayed on the display when a corresponding one of the four-direction-oriented GUI controls is activated corresponding to a selected key selected by the user command.

According to the aforementioned various embodiments, a four-direction UI may be provided to a user so as to propose an interface that reflects users of the display apparatus such that the user may intuitively use various functions of the display apparatus without learning or record of a new type of interface.

Additional and/or other aspects and advantages will be set forth in part in the description which follows and, in part, will be obvious from the description, or may be learned by practice of the embodiments.

### BRIEF DESCRIPTION OF THE DRAWINGS

The above and/or other aspects will be more apparent by describing certain exemplary embodiments with reference to the accompanying drawings, in which:

FIG. 1 is a diagram illustrating a display system according to an embodiment;

FIG. 2 is a schematic block diagram of a configuration of a display apparatus according to an embodiment;

FIG. 3 is a block diagram illustrating a configuration of a display apparatus in detail according to an embodiment;

FIGS. 4 to 13 are diagram for explanation of a method of using a function of a display apparatus according to various embodiments; and

FIG. 14 is a flowchart for explanation of a method for controlling a display apparatus through a four-direction UI according to an embodiment.

### DETAILED DESCRIPTION

Reference will now be made in detail to the embodiments, examples of which are illustrated in the accompanying drawings, wherein like reference numerals refer to the like elements throughout. The embodiments are described below to explain the embodiments by referring to the figures.

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

As the embodiments allow for various changes and numerous embodiments, particular embodiments will be illustrated in the drawings and described in detail in the written description. However, this is not intended to limit the embodiments to particular modes of practice, and it is to be appreciated that all changes, equivalents, and substitutes that do not depart from the spirit and technical are encompassed in the present embodiments. In the description, certain detailed explanations of related art are omitted when it is deemed that they may unnecessarily obscure the essence.

The terms such as “first” and “second” are used herein merely to describe a variety of constituent elements, but the constituent elements are not limited by the terms. The terms are used only for the purpose of distinguishing one constituent element from another constituent element.

The terms used in the present specification are used for explaining a specific exemplary embodiment, not limiting the present concept. Thus, the expression of singularity in the present specification includes the expression of plurality unless clearly specified otherwise in context. Also, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

In embodiments, the terms such as ‘module’ or ‘unit’ should be understood as a unit that processes at least one function or operation and that may be embodied in a hardware manner, a software manner, or a combination of the hardware manner and the software manner. In addition, a plurality of ‘modules’ or a plurality of ‘units’ may be integrated as at least one module to embody at least one processor (not shown) except for a ‘module’ or a ‘unit’ which needs to be embodied in specific hardware.

Hereinafter, the embodiments will be described in detail by explaining exemplary embodiments with reference to the attached drawings. The same or corresponding reference numerals in the drawings denote the same elements, and a repeated explanation thereof will not be given.

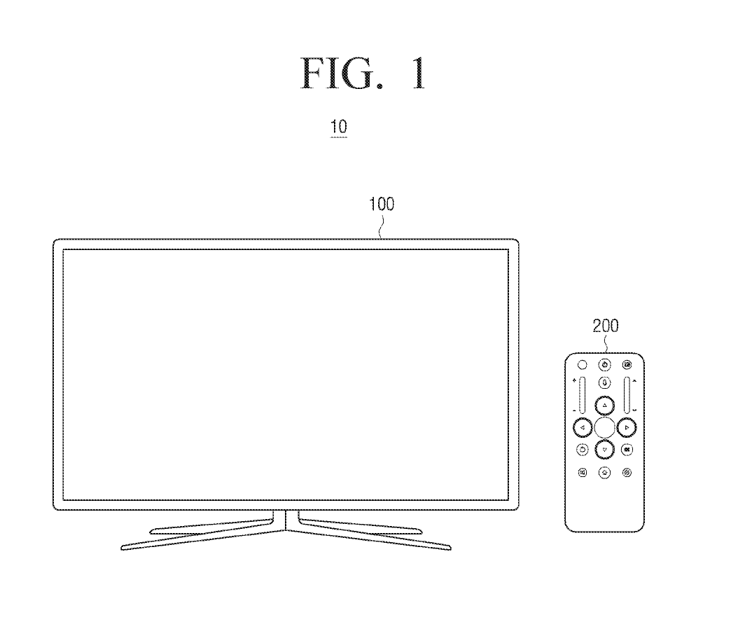

FIG. 1 is a diagram illustrating a display system 10 according to an embodiment. As illustrated in FIG. 1, the display system 10 may include a display apparatus 100 and a remote controller 200. In this case, the remote controller 200 may be a dedicated remote controller for control of the display apparatus 100 with a four-direction key but is merely an embodiment, and thus the remote controller 200 may be embodied as various input devices with a four-direction key, such as a touchscreen or pointing device with a four-direction key and a keyboard. In addition, the display apparatus 100 may be a digital television (TV) but is merely an embodiment, and thus the display apparatus 100 may be embodied as various display apparatus such as a smart phone, a tablet personal computer (PC), a desk PC, a monitor, and a projector.

The display apparatus 100 may display a four-direction user interface (UI) or graphical user interface (GUI) for control of the display apparatus 100. In this case, the four-direction UI (or control/widget) may include a plurality of UI elements, each of which may indicate a high category. A widget (or control) is an element of interaction in a graphical user interface (GUI), like a button or a scroll bar. Controls are that a computer user interacts with through direct manipulation to read or edit information about or control functions of an application.

In addition, upon receiving a user command input through the remote controller 200, the display apparatus 100 may change and display the four-direction UI in response to the user command. In detail, when a user selects one key of the four-direction key contained in the remote controller 200, the display apparatus 100 may select a UI element corresponding to the selected key of the four-direction key. The display apparatus 100 may list and display a low UI element or UI sub element corresponding to a category of the selected UI element.

The remote controller 200 may include a touch sensor and a motion detection sensor, for reception of a user command. In addition, the remote controller 200 may has a pointing function. In order to input a command, the user may push a button of the remote controller 200, and when the remote controller 200 is of a touch type, the user may touch the button of the remote controller 200 or use a pointer.

In particular, the remote controller 200 may include a four-direction key for control of the four-direction UI. The four-direction key may include at least two of an up key, a down key, a right key, and a left key.

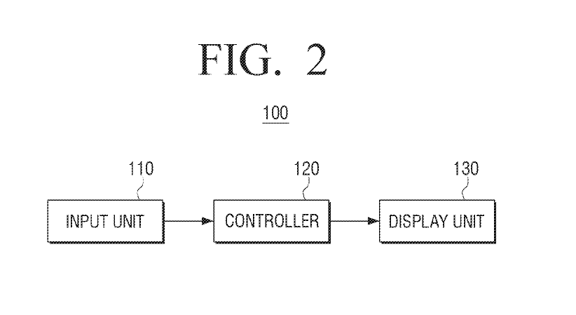

FIG. 2 is a schematic block diagram of a configuration of the display apparatus 100 according to an embodiment. As illustrated in FIG. 2, the display apparatus 100 may include an input unit 110, a controller 120, and a display unit 130.

The input unit 110 may receive a user command for control of the display apparatus 100. When the four-direction UI is displayed, the input unit 110 may receive a user command for selection of the UI element. In particular, the input unit 110 may include remote controller that includes a four-direction key and receives a user command for selection of a UI element through the four-direction key.

The display unit 130 may output image data according to control of the controller 120. In particular, the display unit 130 may display a four-direction UI in which UI elements are arranged to correspond to the four-direction key of the input unit 110 in order to more intuitively access content that a user wants to enter. In this case, the four-direction UI may include at least two UI elements corresponding to the four-direction key, and each of the at least two UI elements may indicate a high category.

The controller 120 may control an overall operation of the display apparatus 100 according to a user command input through the input unit 110. In particular, when the four-direction UI including the UI element is displayed on the display unit 130, if one UI element is selected among UI elements through the input unit 110, the controller 120 may control the display unit 130 to display low UI elements corresponding to a category of the selected UI element around the selected UI element.

In detail, when a user command for generation of the four-direction UI is input through the input unit 110, the controller 120 may control the display unit 130 to display the four-direction UI. The controller 120 may generate the four-direction UI at a position of a pointer, corresponding to a time point when the user command is input, thereby achieving a technological advantage for reducing a movement distance of the pointer to enhance availability

The controller 120 may generate the four-direction UI including UI elements of categories corresponding to contents being displayed when a user command is input. In addition, the user may determine categories that correspond to UI elements included in the four-direction UI, respectively, thereby enhancing user convenience.

When a user command for selection of one of a plurality of UI elements is input to the controller 120, the controller 120 may control the display unit 130 to display low UI elements corresponding to a category of the selected UI element to be arranged in line around the selected UI element. The low UI elements may correspond to a plurality of applications, respectively, and an order for arrangement of low UI elements may be determined based on the high use frequency or the most recent execution using the use frequency of application execution or a recent executed history, thereby achieving technological advantages for allowing a user to access an application that the user frequently uses with low movement.

In addition, the controller 120 may control the display unit 130 to adjust the number of simultaneously displayed low UI elements according to the size of the display unit 130 and to display the low UI elements.

In addition, when a user command for display of the four-direction UI is input, the controller 120 may control the display unit 130 to display the four-direction UI together with a pointer for selection of a low UI element. In this case, a UI may be selected with lower movement than in the case in which a four-direction key is used to move a pointer up, down, right, and left.

In addition, the controller 120 may control the display unit 130 to differently display the selected low UI element from a non-selected low UI element. In detail, the controller 120 may control the display unit 130 the selected low UI element to be large, to be deepened with color, or to be highlighted compared with the non-selected low UI element.

By virtue of the aforementioned display apparatus 100, a user may intuitively access an application to be accessed by reflecting an old habit of controlling the display apparatus 100 with the remote controller 200.

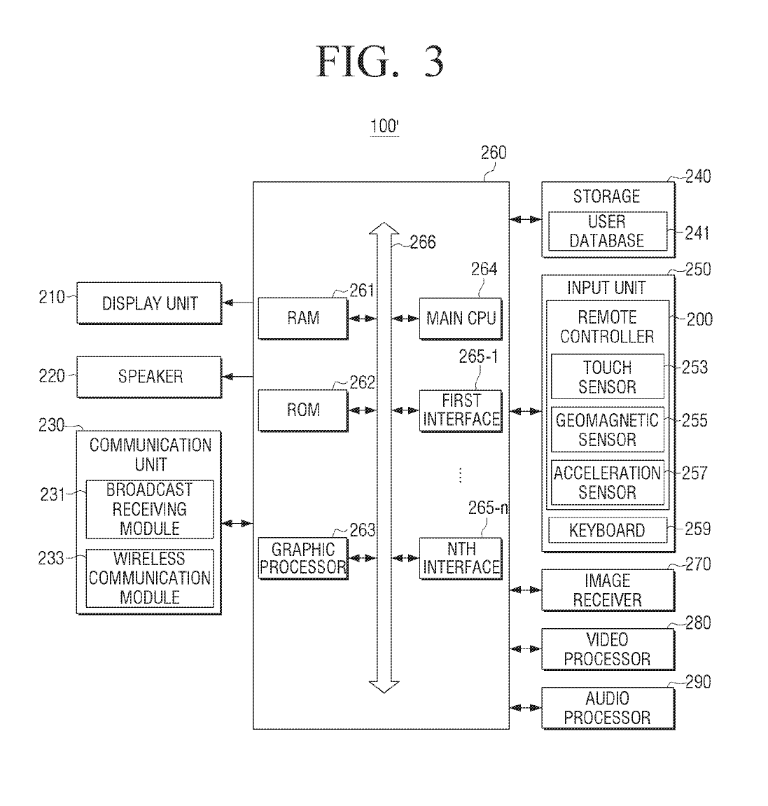

FIG. 3 is a block diagram illustrating a configuration of the display apparatus 100 in detail according to an embodiment. As illustrated in FIG. 3, the display apparatus 100 according to an embodiment may include a display unit 210, a speaker 220, a communication unit 230, a storage 240, an input unit 250, a controller 260, an image processor 270, a video processor 280, and an audio processor 290.

The display unit 210 may display at least one of a video frame formed by processing image data received by the image processor 270 and various images generated by a graphic processor 263. In particular, the display unit 210 may display a four-direction UI including a UI element. In addition, the display unit 210 may display a pointer or a highlight for selection of a UI element of a four-direction UI.

The speaker 220 may be a component for outputting various alarm sounds or voice messages as well as various audio data items processed by the audio processor 290.

The communication unit 230 may be a component that communicates with various types of external devices or external servers using various types of communication methods. The communication unit 230 may include various communication chips such as a WiFi chip, a Bluetooth chip, an NFC chip, and a wireless communication chip. In this case, the WiFi chip, the Bluetooth chip, and the NFC chip may perform communication using a WiFi method, a Bluetooth method, and an NFC method, respectively. Among these, the NFC chip refers to a chip that operates in a band of 13.56 MHz among various RF-ID frequency bands such as 135 kHz, 13.56 MHz, 433 MHz, 860 to 960 MHz, and 2.45 GHz. When the WiFi chip or the Bluetooth chip is used, various information items may be transmitted and received by transmitting and receiving various connection information items such as SSID and session keys and then performing communication using the various connection information items. The wireless communication chip refers to a chip that performs communication according to various communication standards such as IEEE, Zigbee, 3^{rd} generation (3G), 3^{rd} generation partnership project (3GPP), and long term evolution (LTE).

The storage 240 may store various modules for driving the display apparatus 100. For example, the storage 240 may store software including a base module, a sensing module, a communication module, a presentation module, a web browser module, and a service module. In this case, the base module is a basic module that processes signals transmitted from each hardware partition included in the display apparatus 100 and transmits the signals to a high layer module. The sensing module may be a module that collects information from various sensors and analyzes and manages the collected information and may include a face recognition module, a voice recognition module, a motion recognition module, an NFC recognition module, and so on. A presentation module may be a module for configuring a display screen image and may include a multimedia module for reproducing and outputting multimedia content and a UI rendering module for UI and graphic processing. A communication module may be a module for communication with external devices. A web browser module may refer to a module that performs web browsing to access a web server. A service module may be a module including various applications for providing various services.

The storage 240 may store a user database for arranging UI elements using one of the use frequency and the recently executed history of the user.

The input unit 250 may be a command for receiving a user command for control of an overall operation of the display apparatus 100. In particular, the input unit 250 may receive a moving command and a selection command of a highlight displayed on a plurality of UI elements. Alternatively, the input unit 250 may receive a moving command and a selection command of a pointer for selection of one of a plurality of UI elements.

In addition, as illustrated in FIG. 3, the input unit 250 may be embodied as various input devices such as the remote controller 200 and a keyboard 259.

The image processor 270 may receive image data through various sources. For example, the image processor 270 may receive broadcast data from an external broadcaster, receive image data from an external device (e.g., a DVD and a BD player), and receive image data stored in the storage 240.

The video processor 280 may be a component for processing image data received from the image processor 270. The video processor 280 may perform various image processes such as decoding, scaling, noise filtering, frame rate conversion, and resolution conversion on image data.

The audio processor 290 may be a component for processing audio data. The audio processor 290 may perform various processes such as decoding, amplification, and noise filtering on audio data.

The controller 260 may control an overall operation of the display apparatus 100 using various programs stored in the storage 240.

As illustrated in FIG. 3, the controller 260 may include a RAM 261, a ROM 262, the graphic processor 263, a main CPU 264, first to n^{th} interfaces 265-1 to 265-n, and a bus 266. In this case, the RAM 261, the ROM 262, the graphic processor 263, a main CPU 264, the first to n^{th} interfaces 265-1 to 265-n, and so on may be connected through the bus 266.

The ROM 262 may store a command set and so on for system booting. When a turn-on command is input to supply power, the main CPU 264 may copy an operating system (0/S) stored in the storage 240 to the RAM 261 and execute the 0/S to boot a system according to a command stored in the ROM 262. When booting is completed, the main CPU 264 may copy various application programs stored in the storage 240 to the RAM 261 and execute the application program copied to the RAM 261 to perform various operations.

The graphic processor 263 may generate an image containing various objects such as an icon, an image, and a text using a calculator (not shown) and a renderer (not shown). The calculator may calculate an attribute value such as a coordinate value, a shape, a size, color, and so on for displaying each object according to a layout of an image using a control command received from the input unit 250. The renderer may generate various layouts of images including an object based on the attribute value calculated by the calculator. The image generated by the renderer may be displayed in a display area of the display unit 210.

The main CPU 264 may access the storage 240 to perform booting using the O/S stored in the storage 240. In addition, the main CPU 264 may perform various operations using various programs, contents, and data items stored in the storage 240.

The first to n^{th} interfaces 265-1 to 265-n may be connected to the aforementioned various components. One of interfaces may be a network interface that is connected to an external device through a network.

In particular, when the display unit 210 displays a four-direction UI including UI elements, if one of the UI elements is selected through the input unit 250, the controller 260 may control the display unit 210 to display a low UI element corresponding to a category of the selected UI element around the selected UI element. In this case, the UI elements may include a text, an icon, and so on.

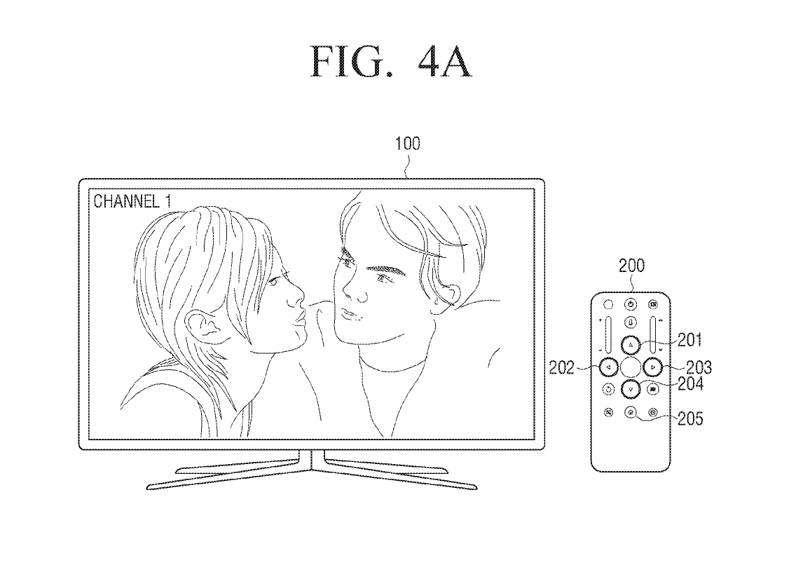

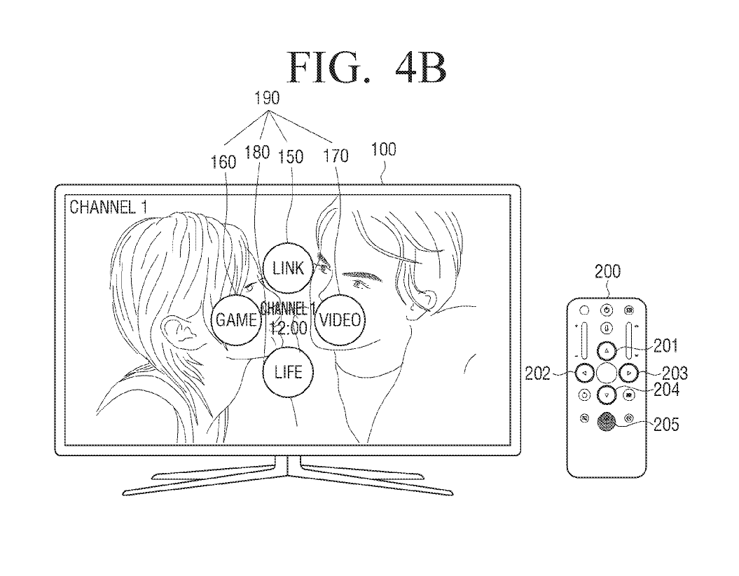

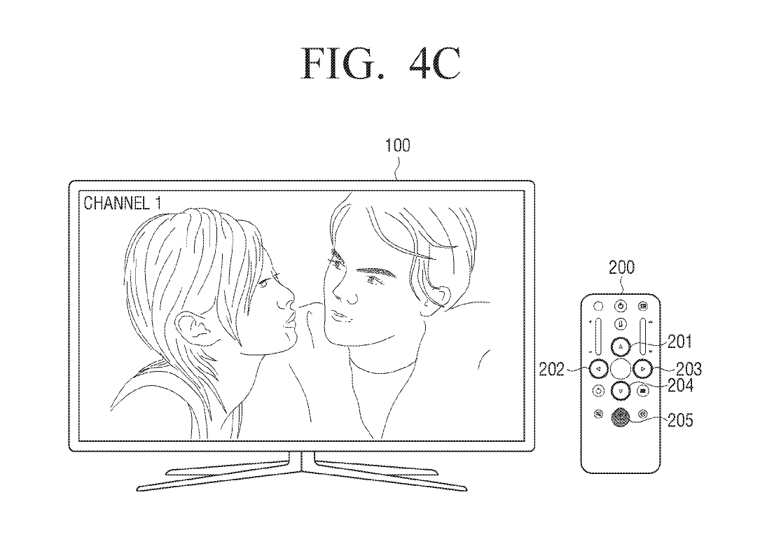

Hereinafter, a method for controlling the display apparatus 100 using the remote controller 200 will be described with regard to various embodiments with reference to FIGS. 4A to 12.

In detail, as illustrated in FIG. 4A, the controller 260 may control the display unit 210 to display channel 1.

As illustrated in FIG. 4A, when a home button 205 of the remote controller 200 for generation of a four-direction UI of the remote controller 200 is selected during display of channel 1, the controller 260 may control the display unit 210 to display a four-direction UI 190 in a central region of a display screen image, as illustrated in FIG. 4B.

In this case, as illustrated in FIG. 4B, the four-direction UI 190 may include a “LINK” icon 150 corresponding to an up key 201 of the remote controller 200, a “GAME” icon 160 corresponding to a left key 202, a “VIDEO” icon 170 corresponding to a right key 203, and a “LIFE” icon 180 corresponding to a down key 204.

In this case, the plurality of icons 150, 160, 170, and 180 included in the four-direction UI 190 may correspond to the shape of the four-direction key of a remote controller.

A method for selecting the home button 205 according to the aforementioned embodiment may include various methods such as a method for pushing short or long the home button 205, a method for touching the home button 205, and a method for continuously inputting the home button 205.

As illustrated in FIG. 4B, during display of the four-direction UI 190, when the home button 205 is re-input, the controller 260 may control the display unit 210 to remove the four-direction UI 190 of a display screen image and to display channel 1, as illustrated in FIG. 4C.

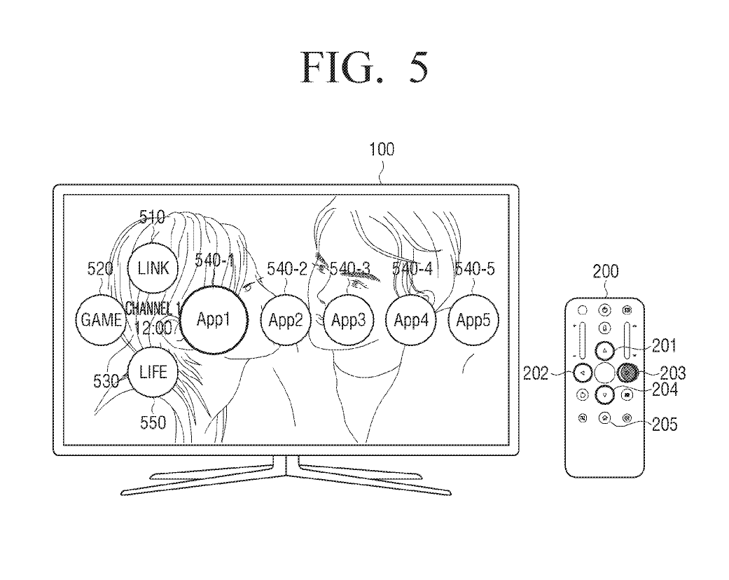

According to an embodiment, as illustrated in FIG. 5, when a user command for entrance into a category “VIDEO 170” is input using the right key 203 of the remote controller 200, the controller 260 may control the display unit 210 to list and display low UI elements 540-1 to 540-5 corresponding to a category “VIDEO 170”.

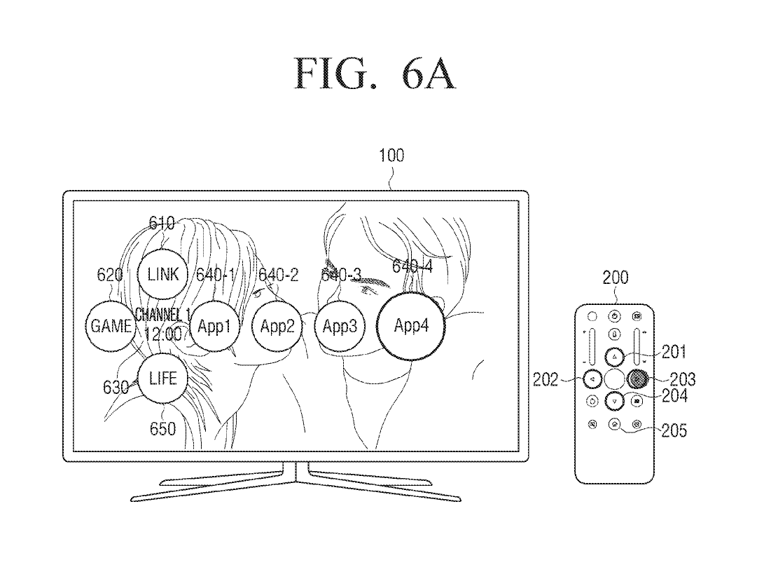

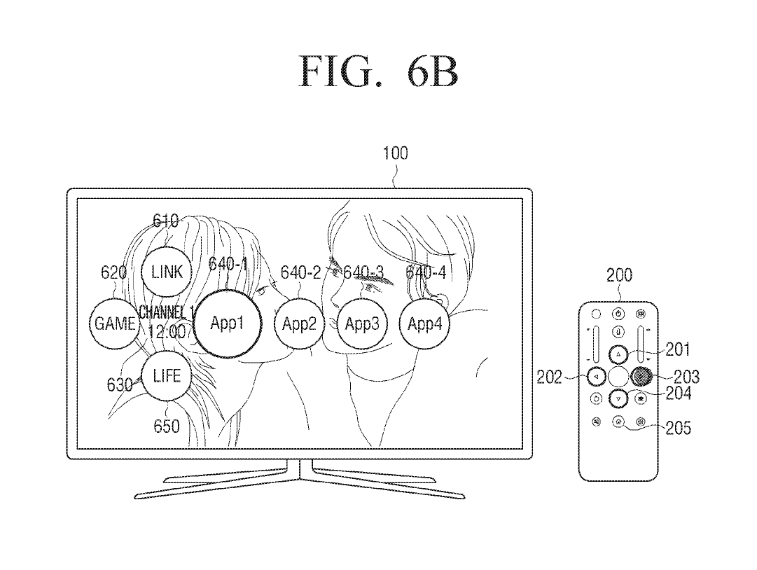

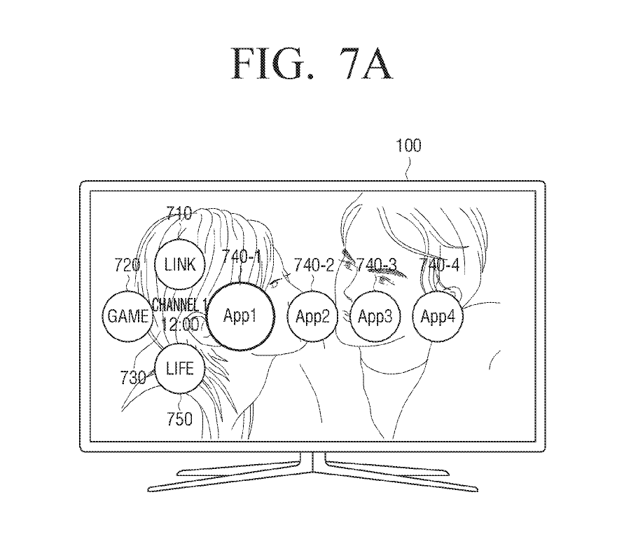

According to an embodiment, a method for manipulating a button of the remote controller 200 to select a UI element will be described with reference to FIGS. 6A and 6B.

The input unit 250 may receive a user command for up, down, right, and left movement using the four-direction key of the remote controller 200. In particular, when a user command for entrance into a category “VIDEO 170” is input to the controller 260 using the right key 203 of the four-direction key of the remote controller 200, the controller 260 may control the display unit 210 to display App1 640-1 to App4 640-4 as low UI elements corresponding to the category “VIDEO 170” to be arrange in line around the icon “VIDEO 170”. As illustrated in FIG. 6A, when a user command is input using the right key 203 of the remote controller 200, the controller 260 may control the display unit 210 to display selection of the App4 640-4.

FIG. 6B illustrates the case in which the App1 640-1 is re-selected. When the number of low UI elements corresponding to the category “VIDEO 170” is 4, if a user command for right movement is input using the right key 203 of the remote controller 200 during selection of the App4 640-4, the controller 260 may control the display unit 210 to re-select and display the App1 640-1 as a first listed low UI element. When the first listed low UI is returned, entrance into another category may be facilitated.

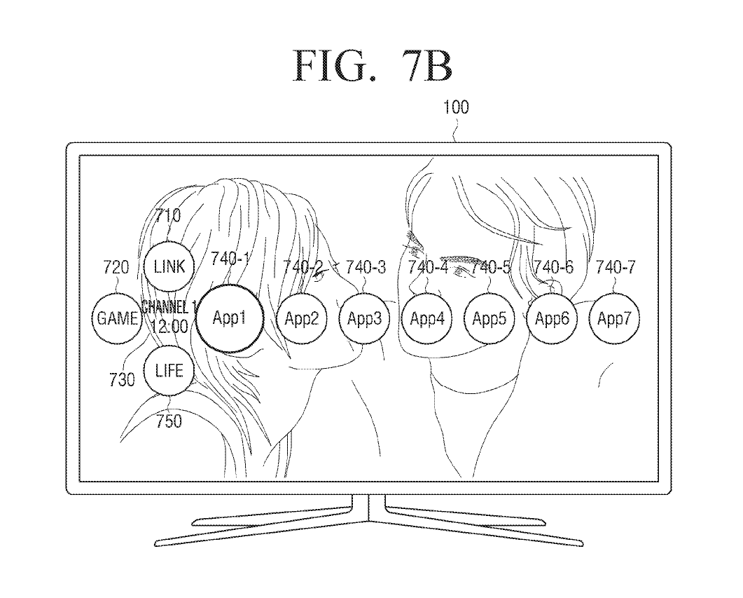

FIGS. 7A and 7B illustrate the case in which the size and number of displayed low UI elements according to the size of a display according to an embodiment. For example, when FIG. 7A illustrates the case in which the display apparatus 100 is a 29-inch TV and FIG. 7B illustrates the case in which the display apparatus 100 is a 55-inch TV, the 29-inch TV may simultaneously display low UI elements 740-1 to 740-4 on a four-elements basis as illustrated in FIG. 7A, and the 55-inch TV may simultaneously display low UI elements 740-1 to 740-7 on a seven-elements basis as illustrated in FIG. 7B.

The controller 260 may control the display unit 210 not to change the size of a UI element with an absolute ratio according to the size of a display unit during display. In detail, the controller 260 may control the display unit 210 to adjust the number of UI elements and to display the UI elements according to the size of the display unit by reducing the number of simultaneously displayed UI elements while maintaining the size of the UI elements when the size of the display unit is equal to or less than a predetermined size and increasing the number of simultaneously displayed UI elements while maintaining the size of the UI elements when the size of the display unit is equal to or more than a predetermined size. For example, the size of the UI element may be prevented from being excessively reduced or enlarged so as to provide a UI optimized to the characteristics of hardware.

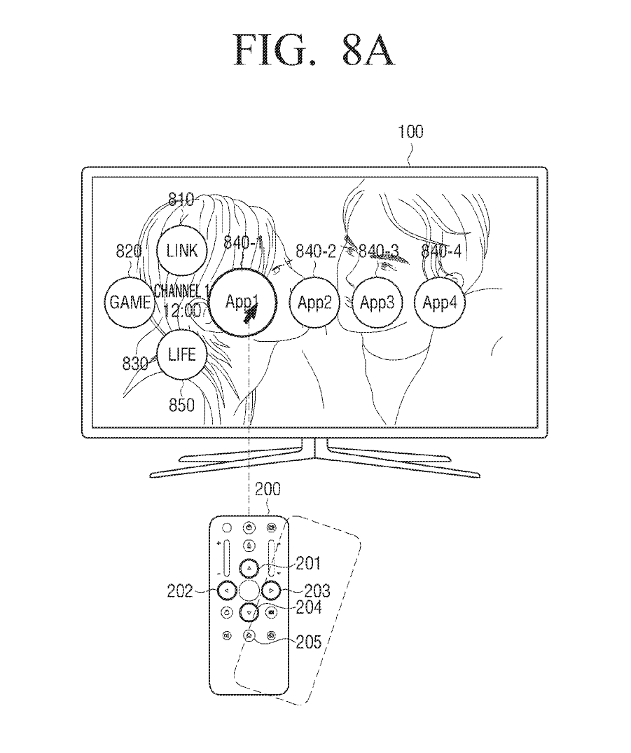

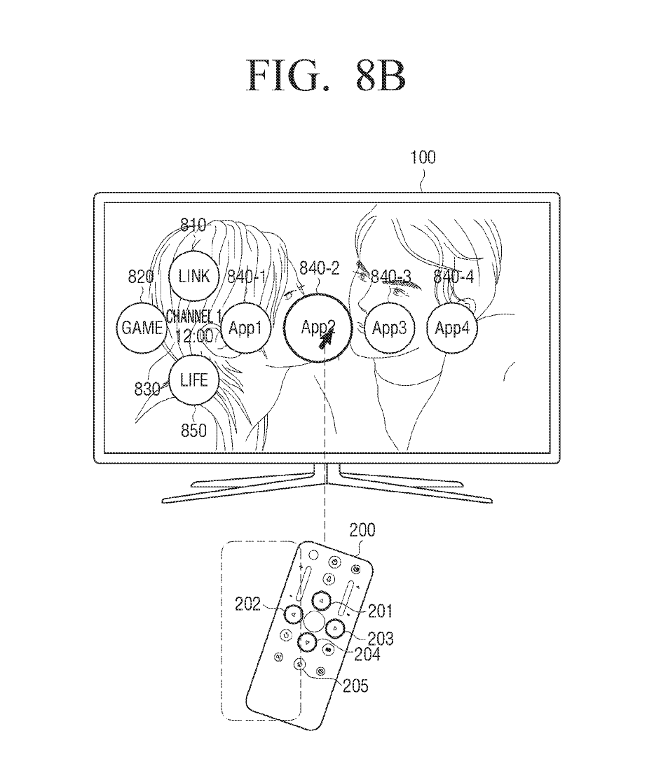

FIGS. 8A and 8B illustrate a method for controlling the display apparatus 100 using a pointer function of the remote controller 200 according to an embodiment. The controller 260 may receive a user command through a pointer moving command and a selection command of the remote controller 200 in order to select one of a plurality of UI elements. When the pointer of the remote controller 200 is used, a UI element to be selected may be rapidly accessed.

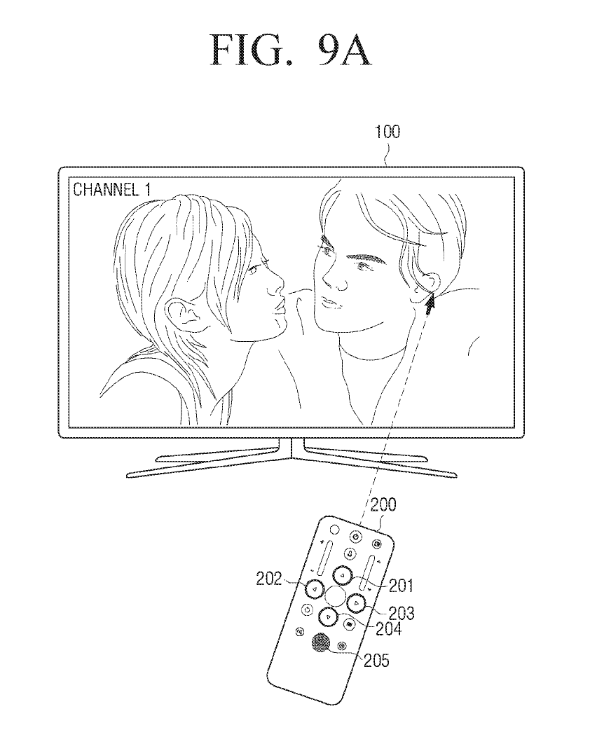

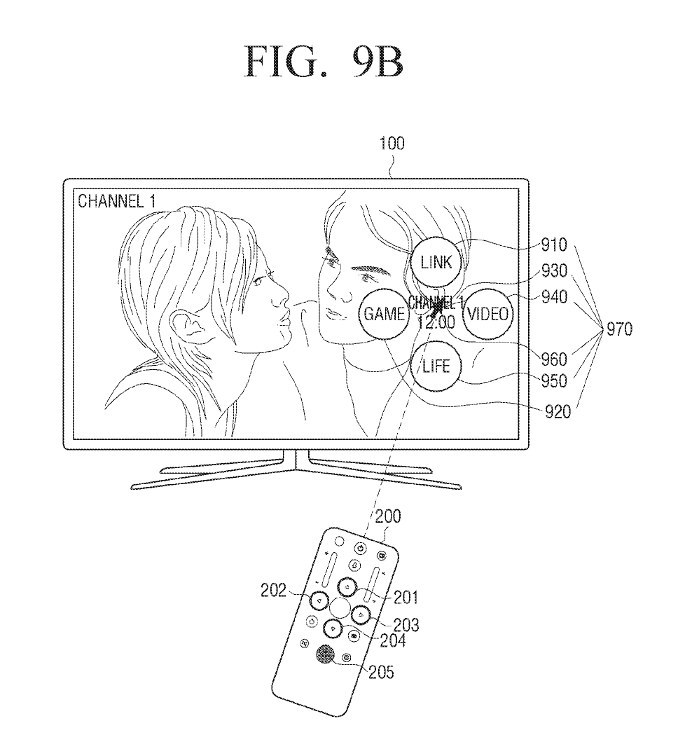

FIGS. 9A and 9B illustrate the case in which a four-direction UI 970 is generated around a position of a displayed pointer 960 when a user command for generation of a four-direction UI is input during display of a pointer, according to an embodiment.

FIG. 9A illustrates the case in which a pointer is displayed in a right portion of the display apparatus 100. As illustrated in FIG. 9A, while the pointer is positioned to the right of the display unit 210, a user command for generating the four-direction UI 970 is input using a home button 250.

Then, as illustrated in FIG. 9B, the controller 260 may control the display unit 210 to display the four-direction UI 970 in the position of the pointer 960. When the four-direction UI 970 is always positioned in a central portion of the display unit 210 during input of a user command for generation of the four-direction UI 970, if the pointer 960 is not positioned in the central portion of the display unit 210, it is cumbersome that a user needs to move the pointer 960 in order to select UI elements 910, 920, 940, and 950.

Accordingly, when the four-direction UI 970 is generated around the position of the pointer 960, corresponding to a time point when the user command for generation of the four-direction UI 970 is input, movement of the pointer 960 may be minimized so as to select a UI.

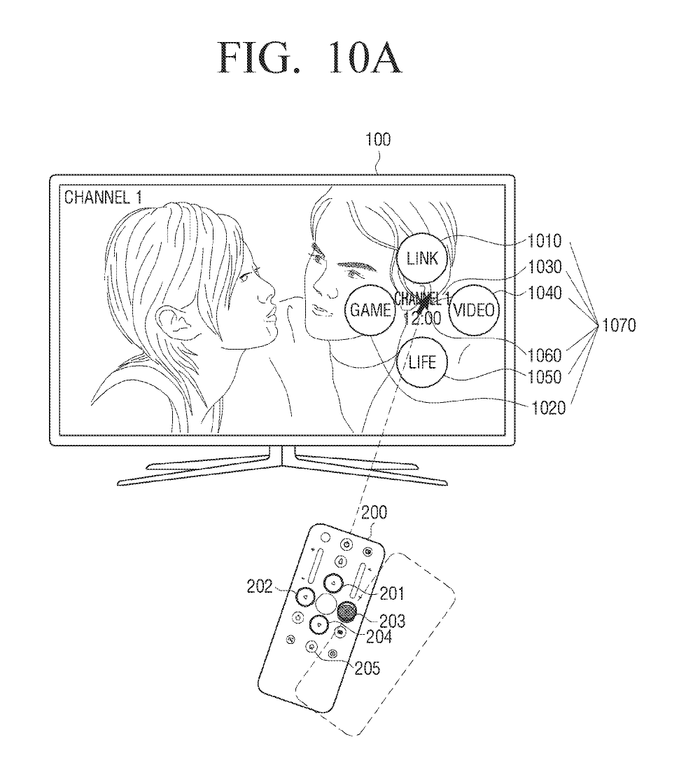

FIGS. 10A and 10B illustrate the case in which the controller 260 controls the display unit 210 to move a position of a four-direction UI and to display the four-direction UI in order to display a low UI element when the four-direction UI is generated at a corner portion of a display apparatus 200, according to an embodiment.

For example, as illustrated in FIG. 10A, while a four-direction UI 1070 is displayed to the right of the display unit, a user command may be input using the right key 203 of four-direction key in order to enter a category VIDEO 1040. When the user command for entrance into the category VIDEO 1040 is input through the right key 203, the controller 260 may control the display unit 210 to move a position of the four-direction UI 1070 to the left of the display unit 210 and to arrange and simultaneously display App1 1040-1 to App4 1040-4 as low UI elements, as illustrated in FIG. 10B.

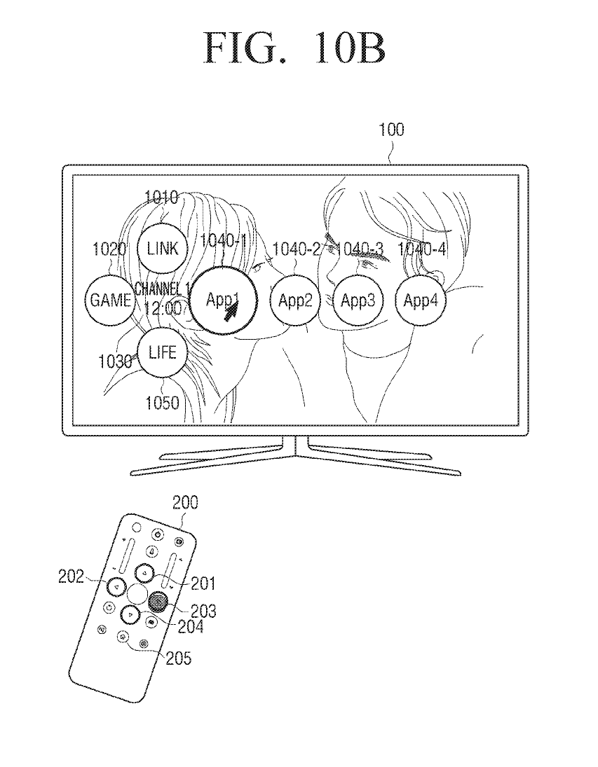

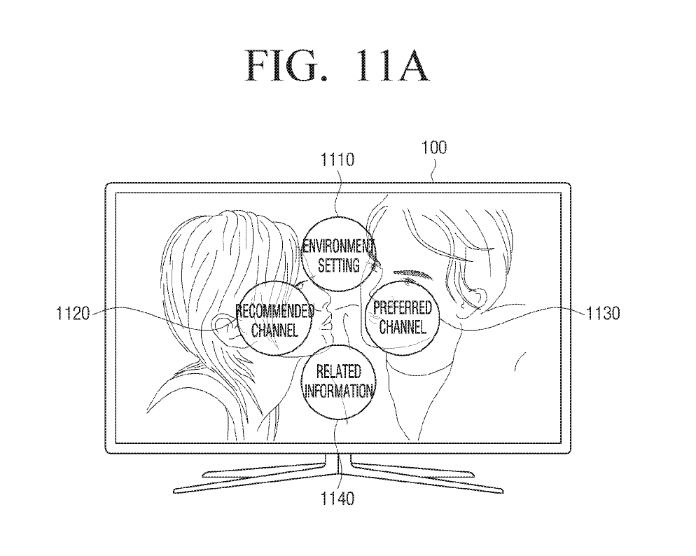

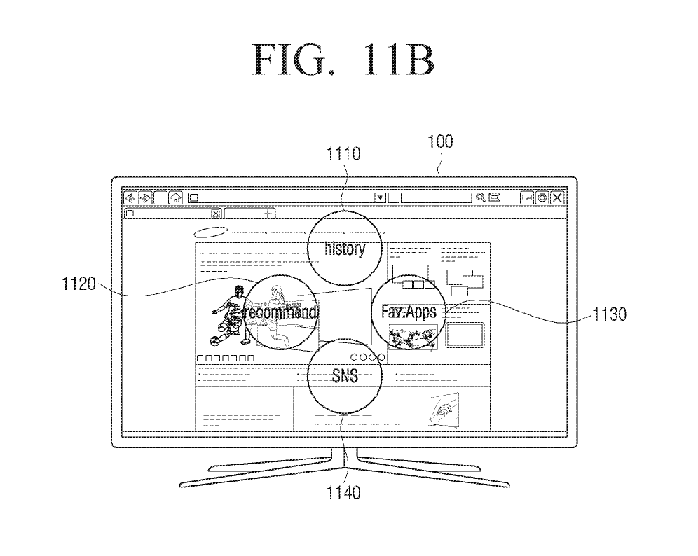

FIGS. 11A and 11B illustrate the case in which a four-direction UI corresponding to specific content is displayed when a user command for generation of the four-direction UI is input during display of the specific content, according to an embodiment.

For example, as illustrated in FIG. 11A, when a user command for generation of a four-direction UI is input during display of broadcast channel 1, the controller 260 may control a display unit 260 to display a four-direction UI including UI elements including environment setting 1110, recommended channel 1120, a user preferred channel 1130, and related information 1140, which are categories corresponding to TV broadcast.

As another example, as illustrated in FIG. 11B, when a user inputs a user command for generation of a four-direction UI during web surfing, the controller 260 may control the display unit 210 to display a four-direction UI including a UI element including a history 1110 showing a list of pages that have been opened by the user as a category corresponding to web surfing, the recommended channel 1120 showing recommended content, Fay.Apps 1130 showing a frequently used application, and a SNS 1140 showing a social network service (SNS) as categories. FIGS. 11 A and 11 B correspond to an embodiment and illustrate the case in which a category is determined by a user.

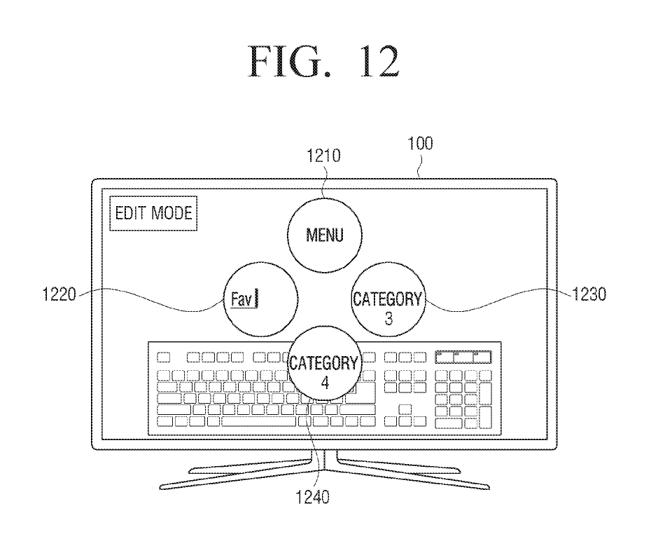

FIG. 12 illustrates the case in which an edit mode for determination of a category of a UI element as a component of a four-direction UI by a user is displayed according to an embodiment. Upon receiving a user command for setting one of UI elements as MENU 1210, setting another UI element as Favorite Application 1220, and setting categories of the remaining UI elements 1230 and 1240, the controller 260 may control the display unit 210 to display UI elements 1210, 1220, 1230, and 1240 as a category determined by the user.

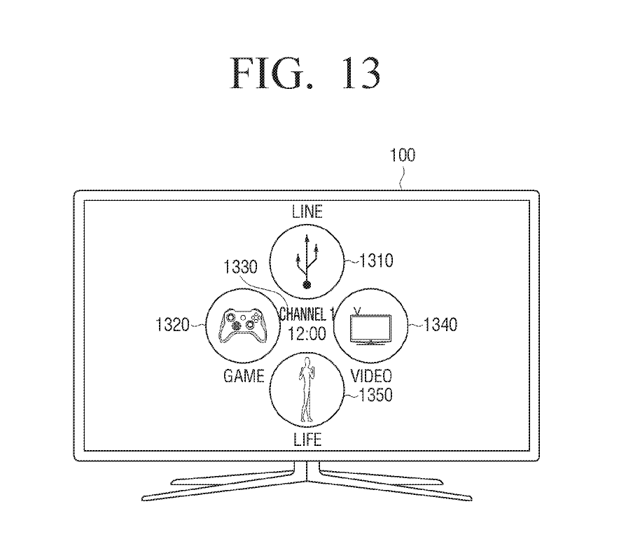

According to various embodiments, although FIGS. 4A to 12 illustrate a UI element as a text, the UI element may be displayed as an icon, a thumbnail, or the like, as illustrated in FIG. 13. In addition, although the drawing illustrates the case in which a selected UI element is displayed to be larger than a non-selected UI element, UI elements may be displayed using different methods. In detail, the selected UI element may be displayed differently from the non-selected UI element by displaying the selected UI element to be highlighted or to be changed with colors.

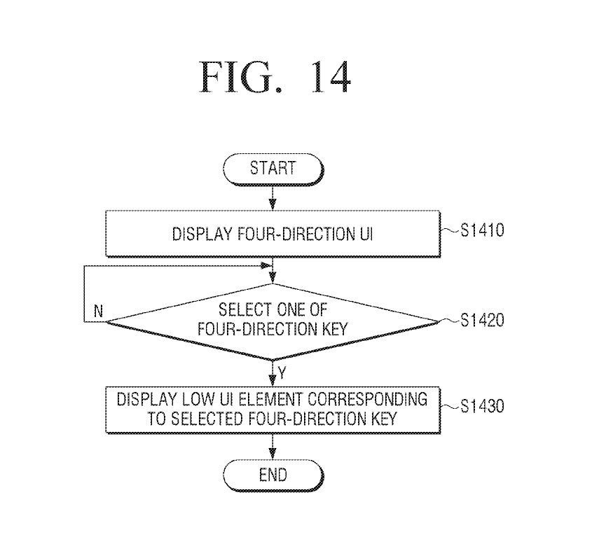

FIG. 14 is a flowchart for explanation of a method for controlling a display apparatus through a four-direction UI according to an embodiment.

First, upon receiving a user command for generation of the four-direction UI, the controller 260 may control the display unit 210 to display the four-direction UI including a UI element (S1410). In this case, the four-direction UI may include UI elements corresponding to the four-direction key of the remote controller 200, and each UI element may include low UI elements corresponding to categories of the UI element.

In addition, upon receiving a user command for selection of UI elements corresponding to the four-direction key, the controller 260 may control the display unit 210 to select and display one of the UI elements according to a user command input using the four-direction key (S1420).

The controller 260 may control the display unit 210 to display a plurality of low UI elements corresponding to categories of a UI element input according to a user command.

The storage 240 may record content used by the user in a user database. The controller 260 may control the display unit 210 to arrange and display low UI elements according to contents that are recently used by the user or the use frequency.

As described above, according to various embodiments, a low UI element corresponding to a UI element that is selected by a user in the four-direction UI may be displayed such that the user may more intuitively enter a category and access desired content using the four-direction UI.

The display control method of the display apparatus according to the various embodiments may be embodied as a program and provided to a display apparatus.

In detail, provided may be a non-transitory computer readable medium for storing a program including displaying a four-direction UI including a UI element corresponding to a four-direction key included in the input unit 250, and upon selecting one of the four-direction key according to a user input, displaying a low UI element included in the UI element corresponding to the selected four-direction key.

The non-transitory computer readable medium is a medium which does not store data temporarily such as a register, cash, and memory but stores data semi-permanently and is readable by devices. More specifically, the aforementioned applications or programs may be stored in the non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting the embodiments. The present teaching can be readily applied to other types of apparatuses. Also, the description of the exemplary embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit thereof, the scope of which is defined in the claims and their equivalents.

What is claimed is:

1. A method for controlling a display apparatus controlled through an input unit comprising a four-direction key, the method comprising:
displaying a four-direction user interface (UI) comprising UI elements corresponding to the four-direction key; and
in response to one of four-direction keys being selected, displaying a UI sub-element included in a UI element corresponding to a selected key.

2. The method as claimed in claim 1, wherein the displaying of the UI sub element comprises displaying a plurality of UI sub-elements aligned with the UI sub element corresponding to the selected key.

3. The method as claimed in claim 2, wherein:
the plurality of UI sub-elements corresponds to a plurality of applications, respectively; and
the displaying of the plurality of UI sub-elements comprises displaying the plurality of UI sub-elements in an aligned order using one of a frequency of execution of the plurality of applications and a recently executed history.

4. The method as claimed in claim 1, wherein:
the displaying of the four-direction UI comprises displaying a pointer together with the four-direction UI in response to a user command for displaying the four-direction UI being input; and
the UI sub-element is capable of being selected by the pointer.

5. The method as claimed in claim 1, wherein, the displaying of the four-direction UI comprises, in response to a user command for generation of the four-direction UI during display of specific content, displaying a four-direction UI corresponding to the specific content.

6. The method as claimed in claim 1, wherein the displaying of the UI sub-element comprises adjusting a number and size of a plurality of displayed UI sub-elements according to the size of a display of the display apparatus and displaying the plurality of displayed UI sub-elements.

7. The method as claimed in claim 1, wherein the displaying of the four-direction UI comprises, in response to a user command for display of the four-direction UI being input during display of a pointer, displaying the four-direction UI around a position of the pointer.

8. The method as claimed in claim 1, wherein a category of the UE sub-element is capable of being determined by a user.

9. The method as claimed in claim 1, wherein the displaying of the UI sub-element comprises moving a position of the four-direction UI on a display based on the position of the four-direction UI and a number of the UI sub-elements.

10. The method as claimed in claim 1, wherein the displaying of the four-direction UI comprises, in response to a user input for selection of the UI sub-element being input, differently displaying a selected UI element from a non-selected UI element.

11. A display apparatus, comprising:
an input unit comprising a four-direction key and configured to receive a user command;
a display unit configured to display a four-direction user interface (UI) comprising UI elements corresponding to the four-direction key; and
a controller configured to, in response to one of four-direction keys being selected, control the display unit to display a UI sub-element included in a UI element corresponding to a selected key.

12. The display apparatus as claimed in claim 11, wherein the controller controls the display unit to display a plurality of IUI sub-elements aligned with the UI sub-element corresponding to the selected key.

13. The display apparatus as claimed in claim 12, wherein:
the plurality of UI sub-elements corresponds to a plurality of applications, respectively; and
the controller controls the display unit to display the plurality of UI sub-elements aligned in an order using one of a frequency of execution of the plurality of applications and a recently executed history.

14. The display apparatus as claimed in claim 11, wherein:
the controller controls the display unit to display a pointer together with the four-direction UI in response to a user command for displaying the four-direction UI being input; and
the UI sub-element is capable of being selected by the pointer.

15. The display apparatus as claimed in claim 11, wherein:
the controller controls the display unit to display the four-direction UI corresponding to specific content in response to a user command for generation of the four-direction UI during display of the specific content.

16. The display apparatus as claimed in claim 11, wherein the controller controls the display unit to adjust a number and size of a plurality of displayed UI sub-elements according to the size of a display of the display apparatus and to display the plurality of displayed UI sub-elements.

17. The display apparatus as claimed in claim 11, wherein, in response to a user command for display of the four-direction UI being input during display of a pointer, the controller controls the display unit to display the four-direction UI around a position of the pointer.

18. The display apparatus as claimed in claim 11, wherein a category of the UE sub-element is capable of being determined by a user.

19. The display apparatus as claimed in claim 11, wherein the controller controls the display to move a position of the four-direction UI based on the position of the four-direction UI and a number of the UI sub-elements and to display the four-direction UI.

20. The display apparatus as claimed in claim 11, wherein, in response to a user input for selection of a UI element being input, the controller controls the display unit to differently display a selected UI element from a non-selected UI element.
